(19) United States
(12) Patent Application Publication
(10) Pub. No.: US 2010/0144363 A1
(43) Pub. Date: Jun. 10, 2010

(54) LOAD-BASED ADAPTIVE INACTIVITY TIMERS

(75) Inventors: Giuseppe De Rosa, Atlanta, GA (US); Arthur Richard Brisebois, Cumming, GA (US)

Correspondence Address: AT&T Legal Department - T&W;Attn: Patent Docketing, Room 2A-207, One AT&T Way, Bedminster, NJ, 07921, US

(73) Assignee: AT&T MOBILITY II LLC, Atlanta, GA (US)

(21) Appl. No.: 12/569,662

(22) Filed: Sep. 29, 2009

Related U.S. Application Data
(60) Provisional application No. 61/121,503, filed on Dec. 10, 2008.

(51) Int. Cl. H04W 72/00

(52) U.S. Cl. 455/452.1

(57) ABSTRACT

System(s) and method(s) are provided to for optimizing cellular network resource utilization under variable load conditions. To optimize resource(s) reallocation, inactivity timers that regulate network resource utilization between activity periods are dynamically adjusted based at least in part on current cell load condition(s). Lookup table(s) or computation based on load-timer mapping(s) can enable, at least in part, configuration of an inactivity timer setting. Inactivity timer values and magnitude of adjustments effected as a function of changes in cell load condition(s) can provide an optimal balance of at least one of network resource utilization; battery life of a served device; or signaling load associated with operation of the device. Inactivity timer setting(s) can be based at least in part on load condition estimates, which mitigate signaling associated with current load condition(s) assessment. Inactivity timers can be autonomously determined.

### CROSS-REFERENCE TO RELATED APPLICATIONS

This application claims the benefit of U.S. Provisional Patent Application Ser. No. 61/121,503, filed Dec. 10, 2008, and entitled “LOAD-BASED ADAPTIVE INACTIVITY TIMERS,” the entirety of which is incorporated herein by reference.

### TECHNICAL FIELD

The subject innovation relates to networked communications and, more particularly, to adaptively configuring inactivity timers, which regulate network resource utilization between activity periods, based at least in part on current cell load condition(s).

### BACKGROUND

In mobile networks, the main telecommunication resources—transmission power and bandwidth—are mostly regulated. Such regulation imposes an upper bound to capacity of the mobile networks; e.g., in cellular networks, wireless resources per cell or sector are limited and thus limit the capacity and communication throughput of the cell or sector. In addition, architecture of mobile networks such as backhaul backbone networks and network management components, also introduce limitation in capacity and throughput. An strategy to mitigate capacity and throughput limitations, and ensuing shortcomings in operation of served mobile devices, wherein the shortcomings include reduced battery life and low perceived quality of service, is to introduce inactivity timers, e.g., a time interval a subscriber occupies a channel after completing a data session. The value of the inactivity timers is that system resources allocated to the subscriber for the data session remain seized for the time interval defined by the inactivity timers, even if there is no activity. By retaining resources after a data session or voice session has terminated, a subscriber can reinitiate a session without incurring signaling associated with re-authorization/re-authentication procedures necessary to establish data session(s).

In conventional mobile networks, for example, several inactivity timers are employed to manage dedicated, shared, and common connections or network resources. Such inactivity timers typically are set to attain a balance between latency performance, device battery life, and processing load such as signaling associated with resource allocation; yet, such inactivity timers are commonly insensitive to operational aspects or characteristics of a subscriber that engages in a data session or voice session. In addition, inactivity timers generally are statically dimensioned, or configured, and blindly applied to non-real-time connection(s) or data session(s), even though such data sessions can demand disparate quality of service (QoS) and be carried out in wireless environments with disparate operational features such as radio link quality, allocated communication power, antenna configuration, or the like. Thus, conventionally defined and utilized inactivity timers generally fail to be efficient, and provide a mild remedy to capacity and resource allocation issues.

### SUMMARY

The following presents a simplified summary of the innovation in order to provide a basic understanding of some aspects of the innovation. This summary is not an extensive overview of the innovation. It is intended to neither identify key or critical elements of the innovation nor delineate the scope of the innovation. Its sole purpose is to present some concepts of the innovation in a simplified form as a prelude to the more detailed description that is presented later.

The subject innovation provides system(s) and method(s) for optimizing cellular network resource utilization under high load conditions. To optimize resource reallocations, inactivity timers that regulate network resource utilization between activity periods are dynamically adjusted based at least in part on current cell load condition(s). Inactivity timer values and magnitude of adjustments effected as a function of, or upon, changes in cell load condition(s) can provide an optimal balance of network or radio resource utilization, battery life of a served device, and signaling load associated with operation of the mobile device. Inactivity timer setting(s) can be based at least in part on load condition estimates, which mitigate signaling associated with current load condition(s) assessment. Inactivity timers can be autonomously determined.

In an aspect, capacity-saving benefits derived from aspects or features described herein are primarily realized at the Uu and IuB interfaces of a mobile network. Additionally, performance is indirectly improved on network components or systems such as Radio Network Controller (RNC) and Serving General Packet Radio Service (GPRS) Support Node(s) (SGSN(s)).

At least three advantages of the aspects or features described herein are the following. (1) Optimization of served mobile device(s) battery life based at least in part on inactivity timer adaptation pattern, e.g., dynamic adjustment pattern. Timer adaptation pattern can mitigate unnecessary signaling and thus preserve battery life. (2) Optimization of duty cycle(s) on active control channels. Adjustment of one or more inactivity timers provides optimal or nearly-optimal time interval of resource allocation prior to resource release, which sets completion of a duty cycle associated with voice or data session(s). (3) In Third Generation (3G) Universal Mobile Telecommunication System (UMTS) High Speed Packet Access (HSPA) networks, allowance of voice call offloading to alternative Radio Access Technology (RAT) or frequency layer(s), or carrier(s) when, for example, URA_PCH state is enabled and the radio access network does not allow inter-RAT or inter-frequency offloading of packet-switched (PS) or multi-RAB (radio access bearer) call sessions from the URA_PCH state, and the cell is in loaded conditions.

Aspects, features, or advantages of the subject innovation can be exploited in substantially any, or any, wireless telecommunication, or radio technology or network, including second generation (2G), third generation (3G), advanced third generation (3.5G), or fourth generation (4G) technology(ies). Moreover, the disclosed aspects, features, or advantages of the subject innovation can be exploited in cellular and non-cellular networks, and non-mobile broadband network(s); e.g., internet or wide-area networks, frame-based or packetized data and voice service networks like broadband cable or internet-protocol-based television. Non-limiting examples of radio technologies or networks in which the subject innovation can be implemented or utilized include femtocell technology; Wi-Fi; Worldwide Interoperability for Microwave Access (WiMAX); Enhanced General Packet Radio Service (Enhanced GPRS); Third Generation Partnership Project (3GPP) Long Term Evolution (LTE); 3GPP UMTS; Universal Terrestrial Radio Access Network (UTRAN); Third Generation Partnership Project 2 (3GPP2) Ultra Mobile Broadband (UMB); HSPA; High Speed Downlink Packet Access (HSDPA); High Speed Uplink Packet Access (HSUPA); or LTE Advanced. Additionally, substantially all aspects of the subject innovation can include legacy telecommunication technologies.

To the accomplishment of the foregoing and related ends, the invention, then, comprises the features hereinafter fully described. The following description and the annexed drawings set forth in detail certain illustrative aspects of the innovation. However, these aspects are indicative of but a few of the various ways in which the principles of the innovation may be employed. Other aspects, advantages and novel features of the invention will become apparent from the following detailed description of the invention when considered in conjunction with the drawings.

### BRIEF DESCRIPTION OF DRAWINGS

FIG. 1 is a schematic wireless environment that can exploit various aspects described herein.

FIG. 2 displays example dependence of an inactivity timer on load level or condition in accordance with aspects described herein.

FIG. 3 is a diagram of example states in a network, mobile or otherwise, and inactivity timers associated with the states and related state transitions in accordance with aspects of the subject innovation.

FIG. 4 is a block diagram of an example system that enables dynamic adjustment of inactivity timers in accordance with aspects described herein.

FIG. 5 illustrates an example system that autonomously configures inactivity timer settings in accordance with aspects of the subject innovation.

FIG. 6 is a block diagram of an example system that configures inactivity timer(s) based at least in part on historical data on load conditions.

FIG. 7 illustrates an example of inactivity timer adaptation based at least in part on load conditions in accordance with aspects described herein.

FIG. 8 illustrates an example of inactivity timer adaptation based at least in part on load conditions in accordance with aspects described herein.

FIG. 9 presents a flowchart of an example method for dynamically adjusting an inactivity timer according to aspects described herein.

FIG. 10 is a flowchart of an example method for establishing cell load condition(s) according to aspects described herein.

FIG. 11 is a flowchart of an example method for configuring inactivity timer setting(s) autonomously in accordance with aspects described herein.

FIG. 12 presents a flowchart of an example method for configuring inactivity timer(s) based at least in part on historical data on load conditions according to features of the subject specification.

FIG. 13 displays a flowchart of an example method for defining a load-timer mapping in accordance with aspects described herein.

FIG. 14 is a block diagram of an example embodiment of a mobile network platform that can implement and exploit various aspects described herein.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As employed in this application, the terms “component,” “system,” “platform,” “resource,” “layer,” “interface,” “selector,” “node,” “decoder,” and the like, are intended to refer to a computer-related entity or an entity related to an operational machine with one or more specific functionalities; these entities can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by software or firmware application executed by a processor, wherein the processor can be internal or external to the apparatus and executes at least a part of the software or firmware application. Yet another example, a component can be an apparatus that provides specific functionality through electronic components without mechanical parts, the electronic components can include a processor therein to execute software or firmware that confers at least in part the functionality of the electronic components. As further yet another example, interface(s) can include input/output (I/O) components as well as associated processor, application, or Application Programming Interface (API) components. While the foregoing examples are directed to a component, the exemplified features or aspects also apply to a system, platform, resource, layer, interface, selector, node, decoder, and the like.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point (AP),” “base station,” “Node B,” “evolved Node B (eNode B),” and the like, are utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows.

Furthermore, the terms “user,” “subscriber,” “customer,” “consumer,” “prosumer,” “agent,” and the like, are employed interchangeably throughout the subject specification, unless context warrants particular distinction(s) among the terms. It should be appreciated that such terms can refer to human entities or automated components supported through artificial intelligence (e.g., a capacity to make inference based on complex mathematical formalisms) which can provide simulated vision or voice, sound recognition, and so forth. The term “prosumer,” when utilized herein, indicates the following contractions: professional-consumer and producer-consumer.

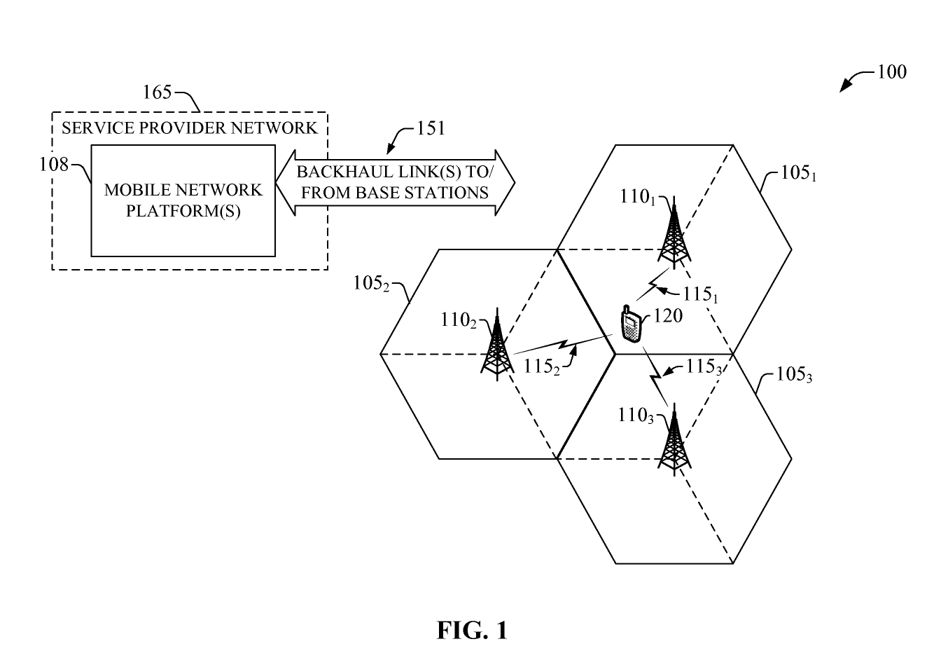

FIG. 1 is a schematic wireless environment 100 that can operate in accordance with aspects described herein. Wireless environment 100 illustrates a set of macro cells. Three macro cells 105₁-105₃ comprise the illustrative wireless environment. Coverage macro cells 105_{λ}, with λ=1,2,3, are illustrated as hexagons; however, coverage cells can adopt other geometries generally dictated by a deployment configuration or floor plan, geographic areas to be covered, and so on. As illustrated, each macro cell 105_{λ} is sectorized in a 2πc/3-radians central-angle configuration in which each macro cell includes three sectors, demarcated with dashed lines in FIG. 1. Other sectorizations, e.g., six-sector cell partitions, are possible and aspects or features of the subject innovation can be exploited regardless of type of sectorization. It is noted that one or more radio network controllers (not shown), which can be a part of mobile network platform(s) 108, and set of base stations (e.g., Node B 110_{λ}) that serve a set of macro cells; electronics, circuitry or components associated with the base stations in the set of base stations; a set of respective wireless links (e.g., links 115_{λ}) operated in accordance to a radio technology through the base stations; form a macrocellular radio access network (RAN). It is noted that based on network features, the radio controller can be distributed among the set of base stations. In an aspect, for UMTS-based networks, wireless links 115_{λ}, embody a Uu interface.

Mobile network platform(s) 108 facilitates or enables circuit-switched (CS)-based (e.g., voice and data) and packet-switched (PS) (e.g., internet protocol (IP), frame relay, or asynchronous transfer mode (ATM)) traffic and signaling generation, and delivery and reception for networked telecommunication in accordance with various radio technologies for disparate markets (e.g., coverage areas). Telecommunication is based at least in part on standardized protocols for communication determined by a radio technology utilized for communication. In addition, telecommunication can exploit various frequency bands, or carriers, which include all electromagnetic (EM) radiation frequency bands licensed by the service provider (e.g., Personal Communication Services (PCS) band(s), advanced wireless services (AWS) band(s), general wireless communications service (GWCS) band(s), and so forth), and all unlicensed frequency bands currently available for telecommunication (e.g., the 2.4 GHz industrial, scientific and medical (ISM) band or one or more of the 5 GHz set of bands). In addition, wireless network platform(s) 108 can control and manage base stations 110_{λ}, in disparate macro cells 105_{λ}, via, for example, a wireless network management component (e.g., radio network controller(s), cellular gateway node(s)). Moreover, wireless network platform(s) can integrate disparate networks, mobile or otherwise, such as for example femtocell network(s), Wi-Fi network(s), picocell network(s), broadband network(s), service network(s), enterprise network(s), or the like. In cellular wireless technologies (e.g., 3GPP UMTS, Global System for Mobile Communication (GSM)), wireless network platform 108 can be embodied, for example, in a core network and a set of radio network controllers (RNCs), with a plurality of RNCs functionally coupled to each serving node, e.g., serving GPRS support node (SGSN), within the CN.

In addition, backhaul link(s) 151 can include wired link components like T1/E1 phone line; a Digital Subscriber Line (DSL) either synchronous or asynchronous; an asymmetric DSL (ADSL); an optical fiber backbone; a coaxial cable; a twisted-pair cable; or the like. Backhaul link(s) 151 also can include wireless link components such as line-of-sight (LOS) or non-LOS links, which can include terrestrial air-interfaces or deep-space links such as satellite communication links for navigation. In an aspect, for UMTS-based networks, wireless backhaul link(s) 151 embodies IuB interface.

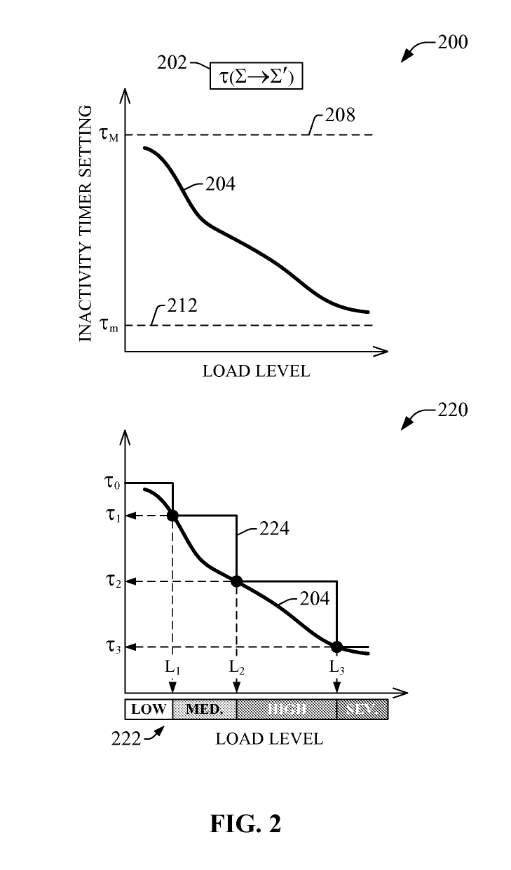

In an aspect of the subject innovation, inactivity timer(s) values or settings are a function of load level(s) in a cell or sector. Load level can be quantified in accordance with a load metric, which can include at least one of (i) current number of active call sessions, (ii) volume of traffic delivered or queued in a DL channel or UL channel, (iii) rise over thermal noise, (iv) processing load in a network management component, system, or node, such as for example RNC or SGSN . . . . Since load level(s) are time dependent, inactivity timer(s) depend implicitly on time through the specific dependence of the inactivity timer(s) on the load level(s); thus, the inactivity timer(s) can be dynamically configured. Inactivity timer(s) can control a time interval that is to elapse prior to release of a specific network system resource, e.g., dedicated channel, shared channel, assigned Context Identification (ID). In addition, in an aspect of the subject innovation, each inactivity timer defined in a network, mobile or otherwise, is typically linked to one or more specific network resources such as shared resources (e.g., configured DL transmit power) or dedicated resources (e.g., dedicated channel, granted bandwidth and packet size for communication device). Moreover, relative relevance of inactivity timers with respect to operation of a wireless network depends at least in part on radio technology employed for communication in the wireless network. In non-mobile networks, such relative relevance of inactivity timers is generally dictated by the technology (e.g., protocol, wired link architecture . . . ) employed for data and signaling communication. Accordingly, dynamic configuration of inactivity timer(s) allows enhancement of network resource management with respect to conventional network systems that utilize statically configured inactivity timers. Dynamic configuration of inactivity timer(s) allows optimization of network resource(s) utilization. FIG. 2 displays example dependence of an inactivity timer on load level in accordance with aspects described herein.

In diagram 200, settings of inactivity timer τ(Σ→Σ′) 202 are determined by a function 204 of load level: A specific load level is mapped, through function 204, to an inactivity timer setting. Function 204 can be defined statically or dynamically by a network operator; such definition can be effected by one or more network management systems (e.g., network operations center (NOC)) or components (e.g., radio network controller (RNC)). In addition, function 204 can be provisioned, e.g., generated, supplied, or retained in memory, by the one or more network management components. Inactivity timer τ(Σ→Σ′) 202 defines a time interval prior to release of resources allocated to a first active, or connected, state E of a device that operates in a network, mobile or otherwise, to a second state Σ′ of the device, wherein Σ′ can be a connected or idle state. Whether the network is mobile or non-mobile, connected state(s) are network specific and are defined based at least in part on a set of available network resources, e.g., transport channels; network processing units, e.g., RNC, SGSN; etc. Based on states E and Σ′, different inactivity timers can be defined and configured to adopt disparate functions of load level and thus different inactivity timer settings.

In an aspect, inactivity timer setting(s) for τ(Σ→Σ′) 204 can have an upper bound τ_{M} 208 and a lower bound τₘ 212, which can be finite or zero. At least one of τ_{M} 208 or τₘ 212 can be statically or dynamically configured.

To regulate signaling associated with configuration of inactivity timer(s) as load condition(s) changes, load levels can be discretized into a set of reference level(s) {L_{κ}}, with K=1, 2 . . . K−1, K, and K a natural number, wherein each of the levels in the set establishes a threshold for load level(s) at which an inactivity timer is automatically adjusted. Such discretization can result in timer setting(s) that are a piecewise constant function 224 of load level(s), as illustrated in diagram 220. Intervals amongst consecutive load level thresholds determine types of load condition(s) 222, such as “low,” “medium (med.),” “high,” or “severe (sev.)”. Therefore, in an aspect, rather than defining a continuous function of load condition(s) for an inactivity timer, timer settings τ_{κ}, can be defined for respective specific values L_{κ}. Two-tuples (L_{κ}, τ_{κ}) can span a lookup table that facilitates or enables utilization of inactivity timers in a network, mobile or otherwise. Values L_{κ}, e.g., L₁, L₂, or L₃, and respectively associated inactivity timer(s) settings τ_{κ}, e.g., τ₁, τ₂, or τ₃, can be defined through experimentation in a laboratory setting or in a deployed network (e.g., beta deployment or accepted deployment) that utilizes the inactivity timer(s), and provisioned (e.g., generated, or recorded in memory) by a network management component. In addition, L_{κ}, values can be adjusted at specific time intervals to reflect operational changes of the network, or at times the network is upgraded (e.g., service is provided through a newer radio technology) or modified (e.g., a sector is added, an antenna at a base station is configured to emit signals at higher power).

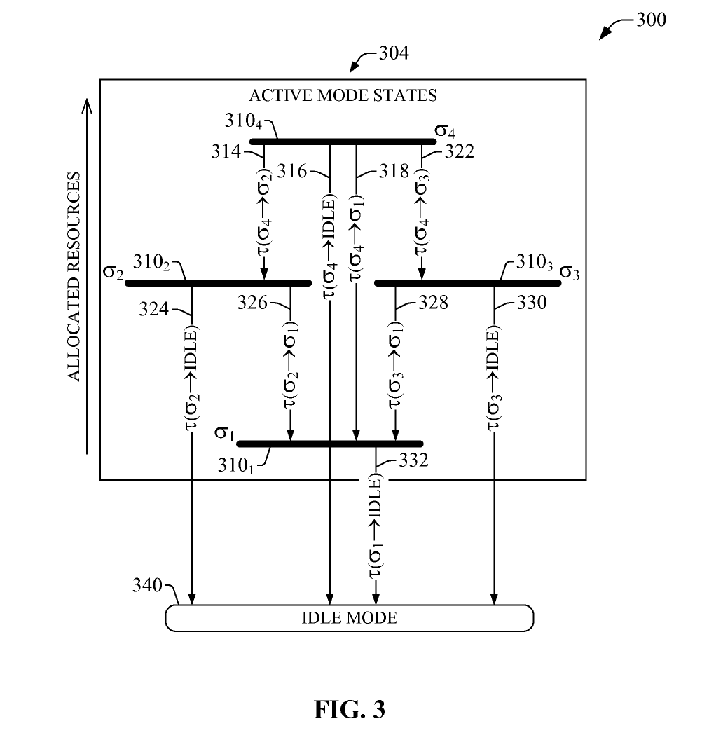

FIG. 3 is a diagram 300 of example states in a network and inactivity timers associated with the states and related state transitions in accordance with aspects of the subject innovation. As illustrated, active mode states 304 include a set of four states σ₁ 310₁ through σ₄ 310₄, which can be arranged in accordance with network resources allocated to a device that operates in one of the active states. In a network, the number of active, or connected, states is typically determined by the number of shared and dedicated channels, e.g., logic channels, transport channels, physical channels, or the like. As indicated hereinbefore, inactivity timers control resource release; thus, a device in an active state with higher allocated resources can transition, or “decay,” to an active state with lower allocated resources. Likewise, all active states can transition to idle state, e.g., Idle mode 340; such transition is the only allowed transition for states with the lowest allocated resources, e.g., σ₁ 310₁ with associated inactivity timer τ(σ₁→Idle) 332. Accordingly, a set of active states inactivity timers τ(σ_{I}→σ_{F}) and τ(σ_{I}→Idle) can be defined; here, indices I, F=1, 2, . . . Q with I>F and Q a natural number; e.g., Q=4 in diagram 300. In addition, functionality of an initial state σ_{I} and a final state σ_{F} can establish “selection rules” for transitions from state σ_{I} to state σ_{F} and thus definiteness of inactivity timer τ(σ_{I}→σ_{F}). Since an inactivity timer is associated with resource release, inactivity timer setting for allowed transitions among states σ_{I} and a final state σ_{F} can be determined by the initial state σ_{I}. For instance, τ(σ₄→σ₃) 322 equals τ(σ₄→σ₂) 314, τ(σ₄→σ₁) 318, and τ(σ₄→Idle) 316. Likewise, τ(σ₂→σ₁) 326 equals τ(σ₂→Idle) 324, and τ(σ₃→σ₁) 328 equals τ(σ₃→Idle) 330. It should be appreciated, however, that in alternative or additional scenarios, mechanism(s) for, or relevancy of, resource release from an initial state to disparate final states can be different and thus the associated inactivity timer settings can de different.

As an example, in a 3GPP UMTS HSPA network, active states can be Radio Resource Control (RRC) connected states, which include URA_PCH state, Cell_DCH, Cell_PCH, and Cell_FACH; where URA UTRAN Registration Area and PCH for Paging Channel, DCH for Dedicated Transport Channel, BCH for Broadcast Channel, FACH for Forward Access Channel, and Cell indicates that location of a device in the active state is associated with a cell in which the device is camped. Inactivity timers associated with these states include the following: τ(URA_PCH→Idle); τ(Cell_PCH→Idle); τ(Cell_FACH→Idle); τ(Cell_DCH→Idle); τ(Cell_FACH→URA_PCH); τ(Cell_DCH→URA_PCH); and τ(Cell_DCH→Cell_FACH). In an aspect, inactivity timer τ(Cell_DCH→Idle)=τ(Cell_DCH→URA_PCH)=τ(Cell_DCH→Cell_FACH)=T₁; τ(Cell_FACH→Idle)=τ(Cell_FACH→URA_PCH)=T₂; and τ(URA_PCH→Idle)=τ(Cell_PCH→Idle)=T₃. T₁, T₂, and T₃ each indicates elapsed time of data inactivity. Inactivity timers T₁ and T₂ affect the following resources, channel elements, codes, IuB resources, DL transmit power, UL interference, user equipment battery draw. In radio access networks implementations or radio technologies that do not allow offloading of a call session initiated in URA_PCH to disparate frequency carrier(s) (e.g., intra-radio access technology (RAT)) or disparate technology (e.g., inter-RAT handover), T₃ affects the foregoing listed resources as well. Timers T₁, T₂, and T₃ affect RNC and SGSN processing load.

It is noted that transitions to idle state after termination of a service session, e.g., a packet-switched voice or data call, or initiation of content delivery to a receiver such as a television set or radio tuner, do not affect processing load in network management component(s) (e.g., RNC) or system(s) (e.g., CN). Accordingly, reduction of τ(σ_{I}→Idle) value can enhance network performance and thus such reduction is to be promoted through suitable adjustment of timer settings as described herein. It should be appreciated that the when a device reaches idle state, it can be promoted to an active state upon establishment of a service session, e.g., establishment of an RCC connection to CELL_DCH or CELL_FACH. In addition, when a device is allocated to a high-resource state, e.g., CELL_DCH, the device can transition to a lower resource state while the device is active and a suitable inactivity timer elapses. Such state transitions affect processing load in network management component(s) (e.g., RNC) or system(s) (e.g., CN). Accordingly, increase of timer settings τ(σ_{I}→σ_{F}) to improve robustness against data inactivity and mitigate multiple transitions at the expense of resource release can mitigated processing load in the network management component(s). Therefore, in scenarios in which a single timer setting is assigned to transitions to idle state and states with lesser allocated resources, e.g., τ(Cell_DCH→Idle)=τ(Cell_DCH→Cell_FACH)=T₁, the tendency to reduce timer setting and increase it is to be balanced.

In an aspect, load level that determines inactivity timer setting, e.g., T₁, can be assessed through a load metric that assigns adjustable weights to loads that promote competing timer adjustment tendencies, e.g., increase vs. reduce, in order to achieve a load level that provides an inactivity timer setting that balances competing loads. In scenarios in which τ(Cell_DCH→Idle) is adjusted independently from τ(Cell_DCH→Cell_FACH), a component (e.g., 420) that adjusts such inactivity timers can regulate the rate of adjustment of timer settings to mitigate a detrimental imbalance among competing loads affected by such timers.

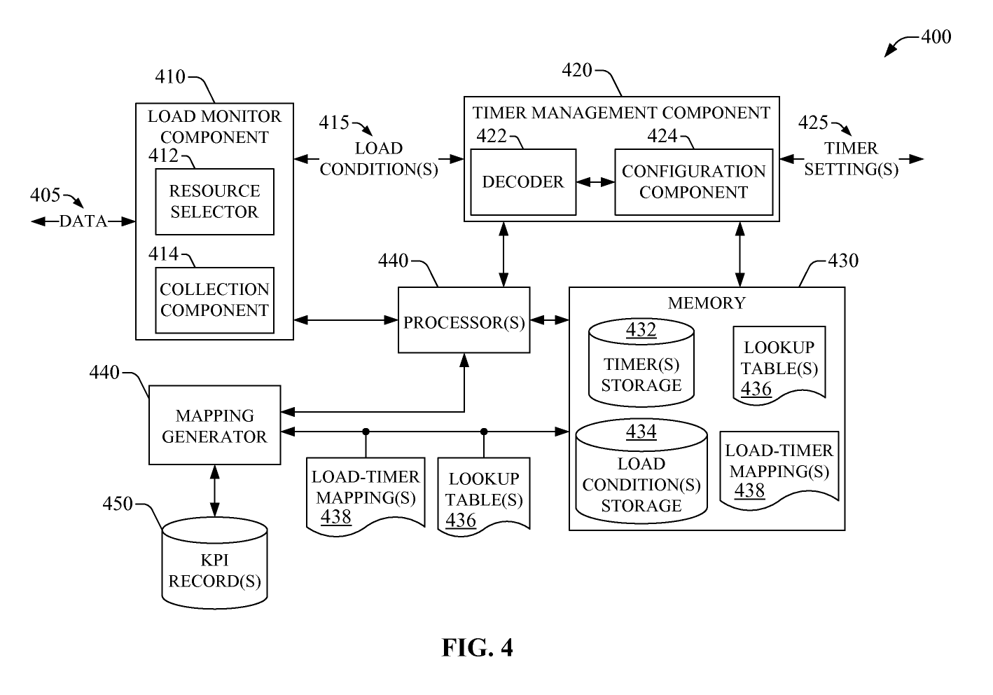

FIG. 4 illustrates a block diagram of an example system 400 that facilitates dynamic adjustment of one or more inactivity timers, or timers, based at least in part on cell load condition(s) in accordance with aspects described herein. Example system 400 can be a part of a mobile network, and can reside at least in part within at least one of a network management system (e.g., radio network controller, core network, or dedicated service network(s)) or a base station. In example system 400, load monitor component 410 monitors a set of one or more network resources associated with a cell or sector to determine current cell load condition(s); resource selector component 412, also referred to as resource selector 412, can identify the set of one or more network resources to be monitored. To assess cell or sector load condition(s) and activate, or trigger, load-based inactivity timer adaptation, load monitor component 410 can monitor one or more identified hardware (H/W) resources and radio frequency (RF) resources. The monitoring can be effected by collection component 414, which can collect data 405 associated with performance of the identified H/W and RF resources. The collection can be accomplished by polling the H/W resources or network components for management thereof or management of RF resources, e.g., a scheduler component that resides within a RNC. As described above, and in a non-limiting example, in UMTS HSPA networks hardware resources associated with a sector/Node B system include at least one of IuB (e.g., bandwidth, Communication Admission Control (CAC)), channel elements (e.g., Digital Signal Processing boards), or processor or server load, while RF resources can include at least one of codes (e.g., scrambling codes or code trees), downlink (DL) transmit power or uplink (UL) receiver power, or UL interference. In addition, monitored hardware resources also can include user-equipment battery draw.

Load monitor component 410 can assess load condition(s) 415 in accordance with a metric that quantifies load level (e.g., number of active call sessions, volume of traffic delivered or queued for delivery in a DL channel or UL channel, rise over thermal noise, processing load in a network component or system, such as RNC or SGSN . . . ), and classify the load level in accordance with a scale of load levels; e.g., Low, Moderate or Medium, or High. The metric that quantifies load level can be determined as a weighted superposition of various loads associated with disparate network resources. The granularity of the load level scale can be statically configured by a network operator, or dynamically configured by load monitor component 410. Level of load condition(s) 415 can be coded via a set of bits and supplied through at least one of broadband control channel(s), management frames, headers of data packets, payload in management packets, short message service (SMS) communication.

Determined level(s) of cell or sector load condition(s) 415 is conveyed to timer management component 420 which can decode load condition(s) 415 message(s) and configure values of a set of inactivity timers based at least in part on the received current cell load condition(s) 415. Timer management component 420 can retain received load condition(s) 415 in memory element load condition(s) storage 434. Decoding and configuration in timer management component 420 can be effected via one or more components therein. In example system 400, in an aspect, decoder 422, also referred herein to as decoder component 422, can exploit lookup table(s) 436 retained in memory 430 to extract a load level in accordance with received load condition(s) 415 message(s). In addition, configuration of the values of the set of inactivity timers can be performed by configuration component 424, which can utilize load-timer mapping(s) 438 to select inactivity timer(s) setting(s); in an aspect, such selection is based on computation of an inactivity timer value through a load-timer mapping with a decoded load level as an argument. Thus, timer management component 420 adaptively or dynamically adjusts inactivity timers in relation to current or substantially current load of a Node B system (e.g., coverage cells, or IuB or backhaul link) As one or more loads increase, as conveyed by load condition(s) 415, inactivity timers can be shortened automatically via timer management component 420. Conversely, as one or more loads decrease as revealed by load condition(s) 415, timer management component 420 can automatically lengthen inactivity timers. Adjustment of inactivity timer setting, as effected by timer management component 420 via configuration component 424, can balance, at least in part, competing sources of load condition(s), e.g., loads that lead to disparate trends in adjustment of inactivity timers, as discussed supra

Values of inactivity timer(s) 225 can be conveyed for utilization within a wireless network operation. Additionally, timer management component 420 can retain generated values of inactivity timers within memory 430, e.g., in memory element timer(s) storage 432.

Mapping generator component 440, also referred to as mapping generator 440, can determine load-timer mapping(s) 438 and lookup table(s) 436, and retain such elements in memory 430; lookup tables can be constructed from load-timer mapping(s) 438 as described above (see FIG. 2). To determine an inactivity timer function of load level, mapping generator can retrieve network performance metrics, e.g., key performance indicators retained in memory element 450, and probe various mathematical functions to attain a satisfactory acceptance level of network performance in a trial deployment or testing phase of a production deployment. Such mathematical functions can be defined as a particular combinations of a predetermined set of basis functions (e.g., polynomial functions, especial functions, sin(•) and cos(•) functions . . . ; not shown). Mapping generator 440 can deliver load-timer mapping(s) 438 or lookup table(s) 436 to memory 430 as a file, via file transfer protocol (FTP), a SMS communication, a set of USSD codes, or a set of bits.

In an aspect, timer management component 420 can configure, via configuration component 424, all inactivity timers utilized in a wireless network or non-mobile network. Timer management component 420 can adjust timer values within a substantial dynamic range—the interval of variation in response to load condition(s) change(s)—since various inactivity timers can span disparate time scales that range from several minutes (e.g., 30 min) to a few seconds (e.g., 5 sec) or less. As a non-limiting illustration of inactivity timer adjustment with substantial dynamic range, it is noted that conventional 3GPP UMTS HSPA implementation(s) do not generally allow offloading action to be triggered, or effected, for normal voice calls, e.g., non-emergency (non-E911 (enhanced 911)) calls, established from URA_PCH state and therefore assigned a multi-radio-access-bearer (multi-RAB) (e.g., speech and data). Thus, when high load conditions for at least one of hardware or RF loads are detected in a cell or sector, the connections and resources thereof in URA_PCH state can be released quickly, e.g., inactivity timer equal or nearly-equal to zero, to idle state in order to maximize offloading opportunity(ies) to an alternative radio access technology (RAT) or frequency carrier.

Example system 400 can include processor(s) 440, which is configured to confer, and confers, at least in part, the described functionality of the various components included example system 400. Processor(s) 440 can execute code instructions (not shown) stored in memory 430, or other memory(ies), to provide the described functionality or implement one or more of the described components or functional elements. Code instructions retained in memory 430 comprise at least instructions to implement method(s) described herein. It should be appreciated that processor(s) 440 can be centralized or distributed. Data can be exchanged among described components or functional elements through at least one of a memory bus, a system bus, an address bus, or a message bus or any other protocol to exchange data among processes.

In an embodiment of system 400, memory 430 can retain one or more of the described components or functional elements and processor 440 can execute such components of functional elements. Alternatively or additionally, a server in a network can embody example system 400, wherein at least one processor and a memory execute or provide functionality to the described components or functional elements. While a plurality of the described components is illustrated as separate entities, in one or more alternative or additional embodiments, a first set of components in the plurality can reside within a second set of components therein.

At least three advantages of the aspects and features described herein are the following. (1) Optimization of served mobile device(s) battery life based at least in part on inactivity timer adaptation pattern, e.g., dynamic adjustment pattern. Timer adaptation pattern can mitigate unnecessary signaling associated with resource request or allocation and thus preserve battery life of a device, mobile or otherwise. (2) Optimization of duty cycle(s) on active control channels. Adjustment of one or more inactivity timers provides optimal time interval of resource allocation prior to resource release, which sets completion of a duty cycle associated with voice or data call session(s). (3) When applied to UMTS HSPA networks, allowance of voice call offloading to alternative radio access technology (RAT) or frequency layers, or carriers, when, for example, URA_PCH state is enabled and the radio access network does not allow inter-RAT or inter-frequency offloading of packet-switched (PS) or multi-RAB (radio access bearer) call sessions from the URA_PCH state, and a cell or sector is in loaded conditions.

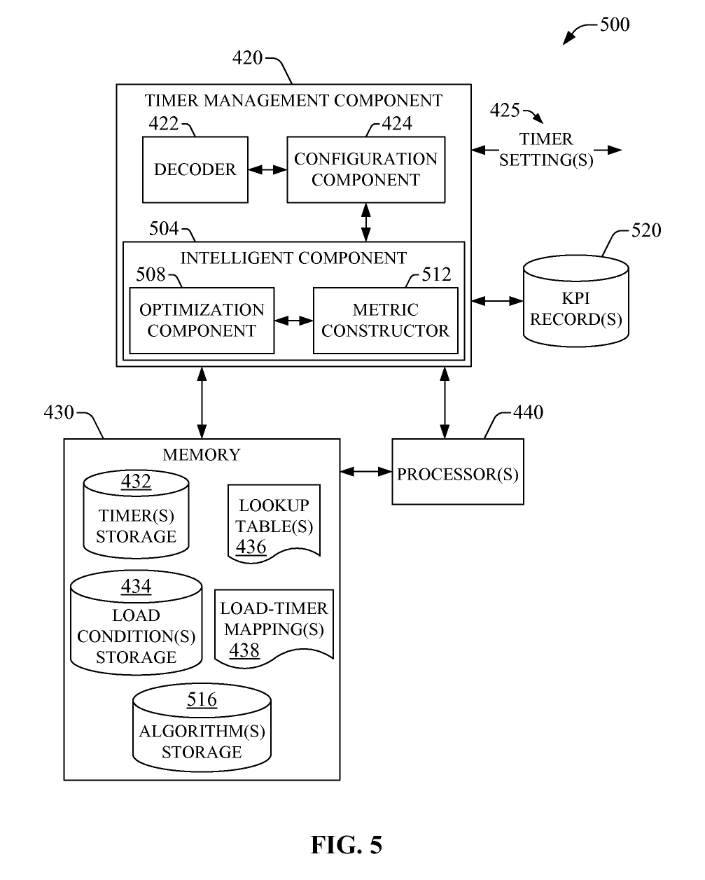

FIG. 5 illustrates an example system 500 that autonomously configures inactivity timer settings in accordance with aspects of the subject innovation. In example system 500, timer management component 420, through one or more components therein, can autonomously determine at least one of upper bound(s) (e.g., τ_{M} 208) and lower bound(s) (e.g., τₘ 212) of an inactivity timer, e.g., τ(URA_PCH→Idle), magnitude of adjustments of the inactivity timer settings upon changes in current load condition(s), or timer settings for a specific load condition. Such autonomous determination can optimize or nearly optimize utilization of network resources as a function of load conditions by providing a dynamic range for adjustment that enables variations of inactivity timers that can balance, at least in part, competing, or opposing, load trends resulting from timer adjustment (see above). Increased complexity or computational expense associated with autonomous configuration of inactivity timer settings is compensated for or overridden by the benefits in network performance provided by optimal or nearly-optimal resource utilization. In order to autonomously determine such upper and lower bounds, and magnitude of adjustments of inactivity timer(s) settings (see, e.g., FIG. 2), in addition to current or substantially current cell load condition(s), timer management component 420, e.g., via intelligent component 504, can include extrinsic information such as (i) historical inactivity timer values or patterns thereof; (ii) correlations among historical values of timers and load condition(s); or (iii) information on network resource upgrades such as new radio technology deployment(s), or inclusion of frequency carrier(s) or band(s) for sector or cell operation. To at least such end, in an aspect, intelligent component 504 can exploit machine learning or artificial intelligence (AI) methods to infer—e.g., reason and draw a conclusion(s) based on complex mathematical formalisms, a set of metrics, arguments, or known outcomes in controlled scenarios—suitable upper and lower bounds of one or more inactivity timers and changes in settings thereof as a function of cell or sector load conditions.

Artificial intelligence techniques typically apply advanced mathematical algorithms—e.g., decision trees, neural networks, regression analysis, principal component analysis (PCA) for feature and pattern extraction, cluster analysis, genetic algorithm, tabu search, or reinforced learning—to a data set; e.g., historical values of at least one of inactivity timers or load conditions. In an aspect, to autonomously determine inactivity timer settings, intelligent component 504 can employ one of numerous methodologies for learning from data and then drawing inferences from the models so constructed; such methodologies can be retained in algorithm(s) storage 516. For example, Hidden Markov Models (HMMs) and related prototypical dependency models can be employed. General probabilistic graphical models, such as Dempster-Shafer networks and Bayesian networks like those created by structure search using a Bayesian model score or approximation can also be utilized. In addition, linear classifiers, such as support vector machines (SVMs), non-linear classifiers like methods referred to as “neural network” methodologies, fuzzy logic methodologies also can be employed. Moreover, approaches that perform data fusion also can be utilized.

In an aspect of the subject innovation, autonomous configuration of timer settings can be implemented at least in part through optimization component 508. For a load condition, or level, optimization component 508 can determine settings of various configured inactivity timers and monitor network performance in order to optimize resource(s) utilization—optimization of resource(s) utilization can be attained through optimization of network performance. For low-level and high-level load conditions, optimization can result, respectively, in an upper bound and lower bound for inactivity timers. Monitoring of network performance can enable identification of optimal or nearly optimal inactivity timer(s) setting(s) through an iterative processes, or search, that terminates if a tolerance or threshold for network performance is attained. Optimization component 508 can implement genetic algorithm, simulated annealing, Monte Carlo simulations, tabu search, or the like, to implement a search of optimal or nearly optimal timers; other optimization algorithms also can be employed and retained in memory element 516. Values of an inactivity timer retained in a lookup table 436 or computed via a load-timer mapping 438 can serve as initial values during optimization of the inactivity timer settings. Optimized setting(s) of one or more inactivity timers and associated load level can be retained in lookup table(s) 436.

In an aspect, to monitor network performance as part of inactivity timer setting(s) optimization, optimization component 508 monitors improvement or degradation of key performance indicators (KPI) of network operation at cell or sector level. The KPIs can include at least one of number of dropped, or abnormally terminated, call sessions; processing load associated with specific traffic; queued data for a particular service or set of subscribers; number of available channels, or available carrier(s) or bandwidth associated therewith; available channel elements. Optimization component 508 can access KPI values through KPI record(s) 520, which can be part of a network database or memory in a backend service platform or network management system, such as a network operations center (NOC); in alternative or additional embodiments, KPI record(s) 520 can be retained in memory 430.

Additionally or alternatively, metric constructor 512, also referred to as metric constructor component 512, can autonomously generate a function of a set of one or more KPIs that measures network performance and thus assesses, at least in part, efficiency of network resource(s) release or resource availability. Optimization component 508 can exploit the generated function to monitor and optimize a set of one or more inactivity timers. In an aspect, the function can be generated through selection of a set of basis functions (not shown) and combination thereof through autonomous assignment of weights or coefficients to each basis function in the selected set; the autonomous assignment can be based at least in part on random assignment subject to a predetermined acceptance function or criterion. The set of one or more KPIs in the argument of the metric can be specific to the one or more inactivity timers that are optimized; specificity can be ascertained by the effect, e.g., resulting improvement or degradation, the inactivity timer has on a KPI.

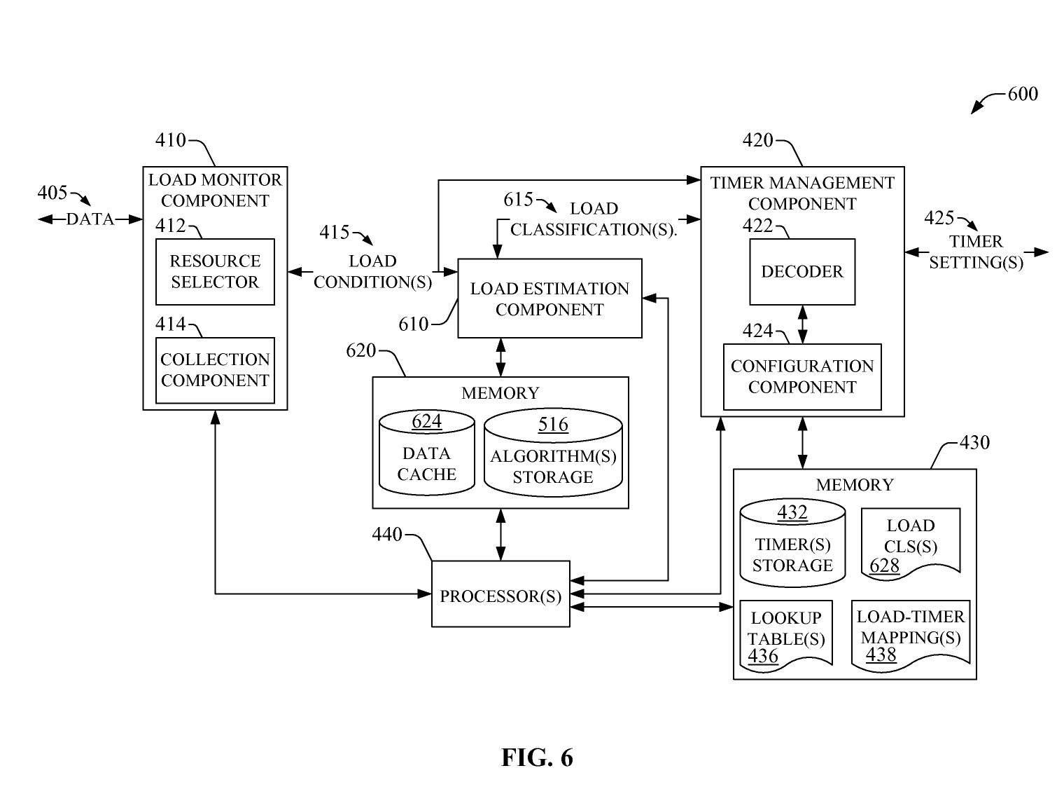

FIG. 6 is a block diagram of an example system 600 that configures inactivity timer(s) based at least in part on historical data on load conditions. Load estimation component 610 can receive load condition(s) 415 and extract a temporal pattern thereof for a specific period of time, e.g., N-hour interval (with N a natural number), e.g., a day, a week, etc. Load estimation component 610 collects load condition(s) data for a time interval that exceeds the specific period of time, and retains the collected load condition(s) in data cache 624 within memory 620. To extract temporal pattern(s) of load conditions, load estimation component 610 can implement one or more of the AI methodologies indicated supra, which can be stored in algorithm(s) storage 516. As part of pattern generation, load estimation component 610 classifies received load condition(s) 415 in accordance with a predetermined group of tiers, e.g., Low, Medium, High, Severe, in order to extract a sequence of classified load conditions within the specific period of time; such sequence embodies the extracted pattern.

Load estimation component 610 can deliver load classification(s) 615, which comprises extracted pattern(s) of load conditions, to timer management component 420 for generation of inactivity timer setting(s) 425 based on load condition(s) conveyed by the received load classification(s) 615. In an aspect, since received load condition(s) are classified, timer management component 420 exploits lookup table(s) 436 to configure a time setting(s) 425. Received load classification(s) 615 can be stored in load classification(s) (CLS(s)) 628. It should be appreciated that in alternative or additional embodiments of example system 600, timer management component 420 also can include intelligent component 504 and associated functionality described hereinbefore.

It should be appreciated that load condition estimates embodied in the extracted pattern(s) can be refined through additional collection of actual load condition(s) and pattern re-extraction. Moreover, predicted classification of load level at a particular instant within the specific period time for which a load condition(s) pattern has been extracted can be compared with an actual classification to assess fidelity or accuracy of an estimated load condition. In an aspect, timer management component 420, via, for example, configuration component 422, can effect such comparison and deliver a message to load estimation component 610 when an estimate and actual value differ by more than a predetermined threshold; the message can convey a request for a new load classification or indicate inaccuracy of estimated load condition(s).

In example system 600, processor(s) 440 is configured to confer, and confers, at least in part, the described functionality of the various components included in the subject example system. As described above, processor(s) 440 can execute code instructions (not shown) stored in memory 430, or other memory(ies), to provide the described functionality; the code instructions comprise instructions to implement method(s) described herein. Code instructions retained in memory 430 comprise at least instructions to implement method(s) described herein. While memories 620 and 430 are illustrated as separate entities, memory elements within such memories can be stored in a single memory, such as memory 430.

In an embodiment of system 600, memory 430 can retain one or more of the described components or functional elements and processor 440 can execute such components of functional elements. Alternatively or additionally, a server in a network can embody example system 600, wherein at least one processor and a memory execute or provide functionality to the described components or functional elements.

While a plurality of the described components in example system 600 is illustrated as separate entities, in some embodiments, a first set of components in the plurality can reside within a second set of components therein. For example, in one of such embodiments, load estimation component 610 can reside within timer management component 420, and be functionally coupled to decoder 422 and configuration component 424, wherein load estimation component 610 can receive load condition(s) 415 through decoder 422.

At least one advantage of estimation of load condition(s), in a sector or cell, provided by example system 600 is that the estimation reduces signaling or processing load incurred to generate real-time or nearly real-time inactivity timer(s).

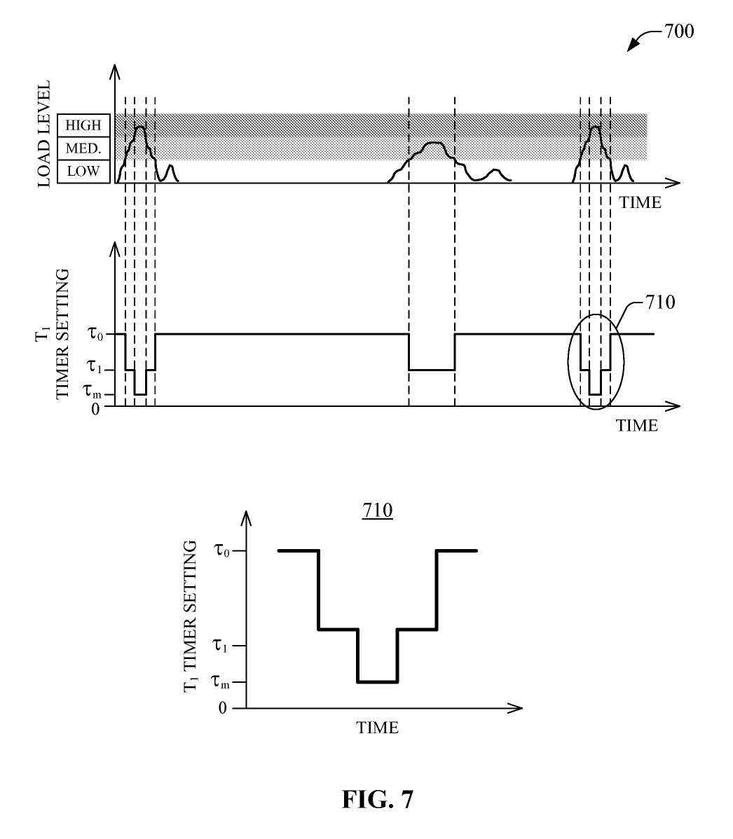

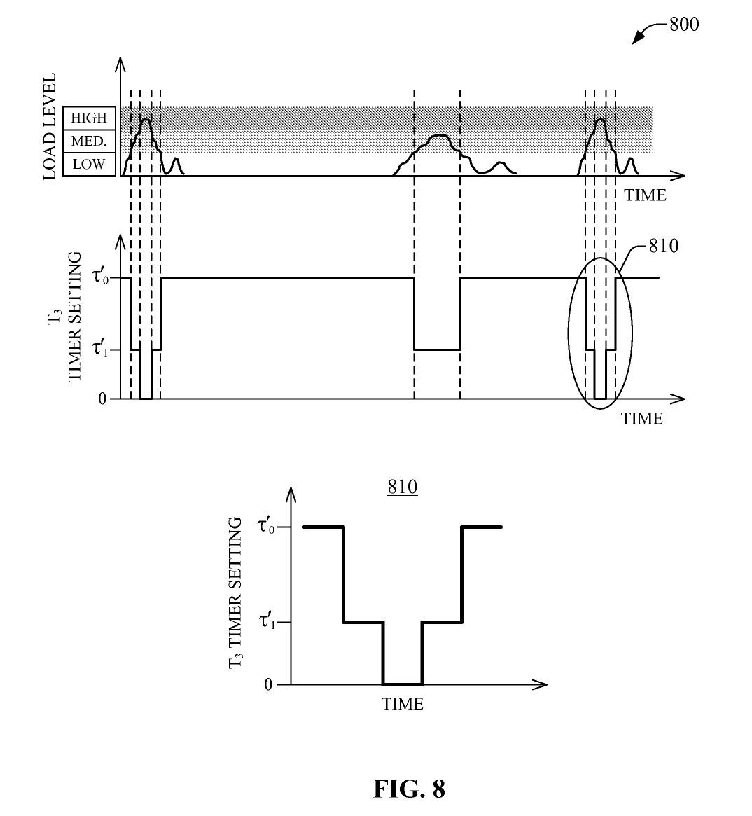

FIGS. 7-8 display diagrams of example inactivity timer adaptation based at least in part on load conditions in accordance with aspects described herein. In an aspect, adaptation is dynamic since load condition(s) (e.g., traffic volume, signaling volume) in a network are time dependent. It is noted that inactivity timers other than those illustrated in diagrams 700 and 800 present substantially the same adaptation response to current sector or cell load conditions. In diagram 700, the example inactivity timer is labeled T₁ and corresponds to at least one of τ(Cell_DCH→Idle), τ(Cell_DCH→URA_PCH), or τ(Cell_DCH→Cell_FACH). Load condition(s) are tiered in three levels, e.g., Low, Medium, and High, and timer values range from a reference value τ₀ (e.g., 30 sec) for low load conditions in the limit that tends to zero, to a minimum value τₘ, e.g., 3 sec. At least one of reference value or the minimum value can be configurable, wherein the minimum value τₘ can be as low as 500 ms or even zero. As displayed in detail 710, inactivity timer τ₁ decreases from τ₀ to τ₁ when load level increases from Low to Medium, and from τ₁ to τₘ when load level increases from Medium to High. As load condition(s) improve, or recover, inactivity timer T1 can be increased from τₘ to τ₁ and from τ₀ to τ₁ when load level changes from Low to Medium and Medium to High.

With respect to diagram 800, the example inactivity timer is labeled τ₃ and corresponds to at least one of τ(URA_PCH→Idle) or τ(Cell_PCH→Idle). Inactivity timer T₃ regulates, at least in part, exploitation of offloading opportunities and efficient utilization of hardware and radio frequency resources during network congestion; reduction of magnitude of T₃ increases offloading opportunities. As in the case of inactivity timer T₁, load condition(s) is tiered in three levels, e.g., Low, Medium (Med.), and High. In diagram 800, timer values, or settings, range from a reference value T′ₒ (e.g., 30 min) for Low load conditions in the limit that tends to zero, to a minimum value τₘ, e.g., 3 sec. at high load conditions. The minimum value τₘ is configurable and can reach values as low as zero, as illustrated. For τₘ=0, at least a portion of network resources for communication allocated to a subscriber with an active voice or data session are released immediately or substantially immediately after the voice or data session terminates. Timer T₃ has a substantially larger dynamic range than T₁; for instance, T₃ can range from 30 min to 5 sec.

As presented in detail 810, inactivity timer T₃ decreases from τ′₀ to τ′₁ when load level increases from Low to Medium. Such decrement increases offloading opportunities because devices allocated in URA_PCH transition to Idle state more quickly. When load level increases from Medium to High, T₃ decreases from τ′₁ to τₘ=0.

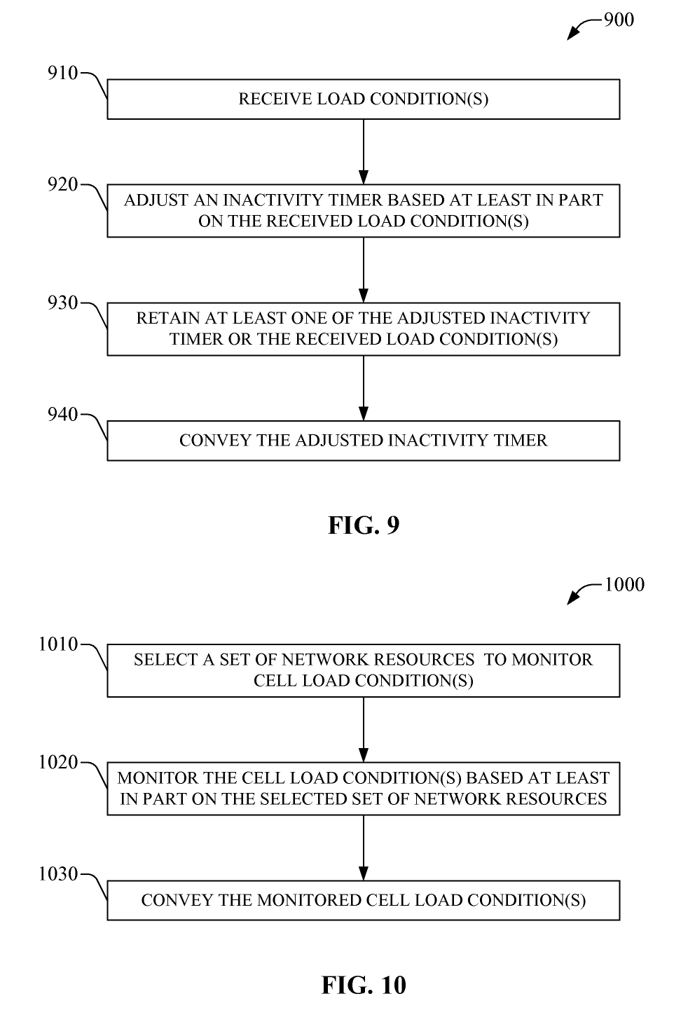

In view of the example system(s) described above, example methods that can be implemented in accordance with the disclosed subject matter can be better appreciated with reference to flowcharts in FIGS. 9-13. For purposes of simplicity of explanation, example methods disclosed herein are presented and described as a series of acts; however, it is to be understood and appreciated that the disclosed subject matter is not limited by the order of acts, as some acts can occur in different order and/or concurrently with other acts from that shown and described herein. For example, one or more example methods disclosed herein could alternatively be represented as a series of interrelated states or events, such as in a state diagram. Moreover, interaction diagram(s) may represent methods in accordance with the disclosed subject matter when disparate entities enact disparate portions of the example methods. Furthermore, not all illustrated acts may be required to implement a described example method in accordance with the subject specification. Further yet, two or more of the disclosed example methods can be implemented in combination with each other to accomplish one or more features or advantages described herein. It should be further appreciated that the example methods disclosed throughout the subject specification are capable of being stored on an article of manufacture to facilitate transporting and transferring such methods to computers or other devices for execution, and thus implementation, by a processor or for storage in a memory. The disclosed example methods can be stored in a memory or computer-readable medium as device-accessible or computer-readable programming code instructions, which can be executed by one or more processors or components to carry out or implement one or more of the disclosed acts comprised in the example methods.

FIG. 9 presents a flowchart of an example method 900 for dynamically adjusting an inactivity timer according to aspects described herein. A mobile network management component, e.g., timer management component 420, can effect the subject example method 900. In an aspect, at least one processor that confers, at least in part, functionality to the mobile network management component can enact the subject example method 900. While illustrated for a wireless network, the subject example method 900 can be carried out in a non-mobile network, such as a cable broadband network. At act 910, load condition(s) are received. Such load condition(s) can refer to current or substantially current cell or sector load condition(s), and thus are local to a particular coverage region(s) of a wireless network and linked to a specific served sector or cell. Received load condition(s) also can include load level(s) at network management component(s) or system(s) that are associated in a one-to-many relationship with a cell or sector, such as an RNC(s), SGSN(s), IuB interface, etc. In a non-mobile network, load condition(s) can correspond to region where a specific service, e.g., high-speed internet, or pay-per-view programming, is provided. Receiving load condition(s) also can include decoding thereof or any associated content. Load condition(s) can be received in at least two modes: (i) real-time or nearly real-time, as the load condition(s) are estimated or computed; or (ii) scheduled at intervals dictated by a set of one or more operational delays determined, or configured, by a network operator. In an illustrative scenario, the network operator can configure an operation delay as “event based.” Such operational delay can be associated with a sampling time interval during which data linked to metrics employed to determine load condition(s) is collected. In another aspect, signaling embodied in a set of bits received through one or more broadband control channels can convey at least in part the load condition(s). It should be appreciated that the load condition(s) can be received through substantially any or any other mechanism(s) for information or signaling delivery, e.g., short message service (SMS) communication, multimedia message service (MMS) communication, or Unstructured Supplementary Service Data (USSD) codes. Received load condition(s) can be encoded, e.g., through a set of one or more bits, according to a load condition scale which can include various load level(s); e.g., Low, Medium, High, Severe; granularity of the scale can depend at least in part on metrics utilized by a network component (e.g., Node B, RNC) or sub-components therein to determine the load condition(s).

At act 920, an inactivity timer is adjusted based at least in part on the received load condition(s). In an aspect, value of an inactivity timer is determined at least in part as a tradeoff between operational performance and available resources. As described supra, magnitude of inactivity timer adjustment can vary based on received load level(s) and changes thereof as described supra. The adjustment can be dictated by computing an updated inactivity timer setting through a mapping (e.g., 204) amongst load level and inactivity timer value. Alternatively, inactivity timer adjustment can be determined by accessing a lookup table of (load condition, timer setting) tuples. As a result of computation of inspection of a lookup table, when a load level condition changes from Low to Medium, the setting, or value, of inactivity timer τ(Σ→Σ′) can be adjusted by Δt from an initially predetermined configurable reference value τ₀, while a change in load condition(s) from Medium to High can result in an adjustment of magnitude α·Δt, with α a real number greater or equal than unity. When load condition(s) attain the highest value in a predetermined load level scale, the value of inactivity timer τ(Σ→Σ′) can be adjusted to a shortest value, which can range from τ(Σ→Σ′)=0, e.g., resources are released immediately after a voice call or data session is terminated, to τₛₕₒᵣₜ, wherein τₛₕₒᵣₜ is a finite configurable value typically smaller than τ₀.

It is noted that τₛₕₒᵣₜ, or any value of the inactivity timer, can be determined autonomously based on at least one of historical values assigned to the inactivity timer or extrinsic information on sector or cell capacity or performance; e.g., information on sector resource upgrades such as new technology deployment(s) or addition of frequency carrier(s) or band(s) for sector or cell operation. In an aspect, autonomous determination can be based on cost-utility analysis to accomplish an optimal or nearly-optimal trade-off among performance and available resources. In an aspect, the cost-utility analysis can predict the result of adjusting inactivity timers that lead to competing, or opposing, load condition trends, as described above, and evaluate the benefit of favoring at least in part one of such trends. Prediction can be based at least in part on historical data or performance experimentation in a network in which the inactivity timer management as described herein is implemented. As described above, to accomplish autonomous determination, artificial intelligence techniques or machine learning methods can be employed.

At act 930, at least one of the adjusted inactivity timer or the received load condition(s) are retained. Such retention can facilitate or enable, at least in part, autonomous generation of timer values and timer adjustments in response to changes in current cell load condition(s), as described above. At act 940, the adjusted inactivity timer is conveyed.

FIG. 10 is a flowchart of an example method 1000 for establishing cell load condition(s) according to aspects described herein. One or more network component(s), e.g., a core network or component(s) therein, a radio network controller (RNC) or control node(s), or a base station or component(s) therein, can effect the subject example method 1000. In an aspect, at least one processor that confers, at least in part, functionality to the one or more network component(s) can enact the subject example method 1000 through execution of program modules or code instructions retained in a memory. At act 1010, a set of network resources is selected to monitor cell load condition(s). The selected set of network resources can pertain to a cell or sector and can include hardware resources or radio resources, as described above. In addition, the set of selected resources includes network resources that are impacted by a predetermined set of one or more inactivity timers. At act 1020, the cell load condition(s) are monitored based at least in part on the selected set of network resources and data associated therewith and employed to generate load condition(s) and indicator(s) thereof. The cell condition(s) are monitored in at least one of two modes: (1) real-time or nearly real-time, or (2) as data associated with the network resources become available. At act 1030, the monitored cell load condition(s) are conveyed. In an aspect, to convey monitored load condition(s), information on such condition(s) can be coded via a set of bits and delivered through at least one of broadband control channel(s), management frames, headers of data packets, or payload in management packets. Additionally or alternatively, the load condition(s) can be delivered through a SMS communication, a set of USSD codes, or an multimedia service (MMS) communication.

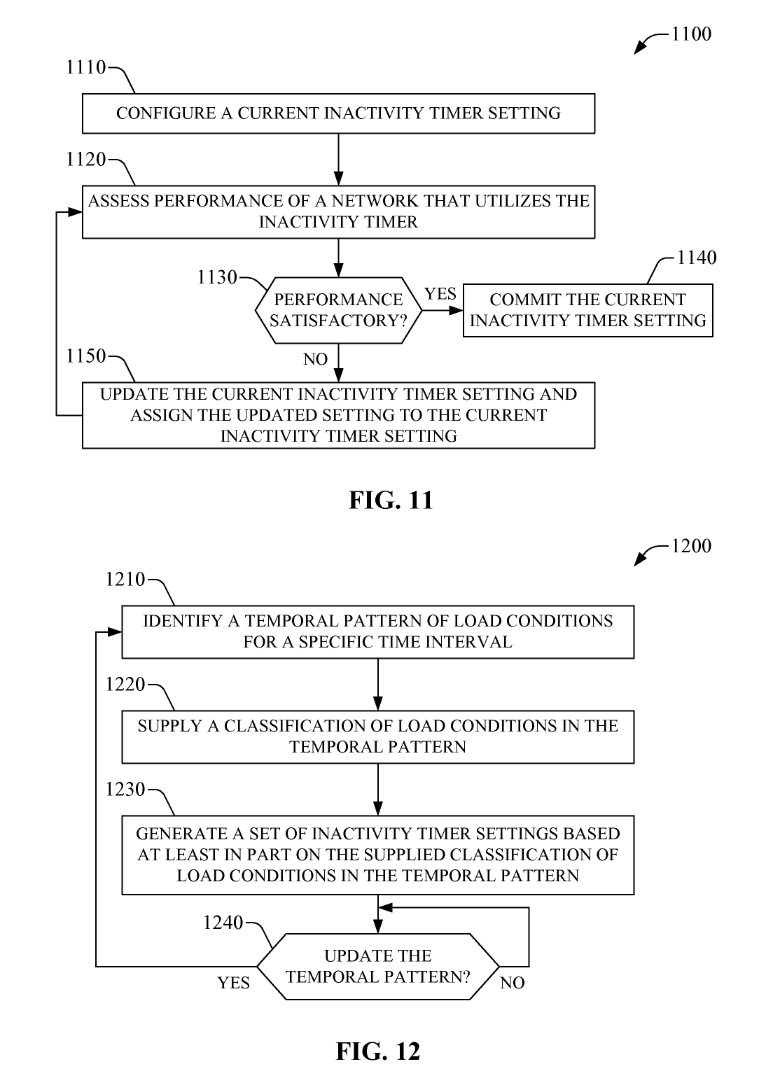

FIG. 11 is a flowchart of an example method 1100 for configuring inactivity timer setting(s) autonomously in accordance with aspects described herein. In an aspect, the subject example method can be a part of act 920 described hereinbefore, and can be implemented by a network management system, or one or more components therein, e.g., load estimation component 610 or timer management component 420. In another an aspect, one or more processors that confer functionality to the network management system, or the one or more components therein, also can carry out, at least in part, the subject example methods. In yet another aspect, one or more processors that execute at least a portion of the network management system, or the one or more components therein, also can perform at least part of this example method 1100. At act 1110, a current inactivity timer setting is configured. Such configuration can be based on an initial value extracted from a lookup table of computed based at least in part on a load-timer mapping, e.g., 438. At act 1120, performance of a network that utilizes the inactivity timer is assessed. The assessment can be performed through a set of KPIs or a performance metric defined there from, as described supra. At act 1130 it is probed if network performance is satisfactory. In the affirmative case, the current inactivity timer setting is committed at act 1140. In the negative case, at act 1150, the current inactivity timer setting is updated and the updated setting is assigned, e.g., logically assigned, to the current inactivity timer setting, and flow is directed to act 1120. Update strategy is determined by a specific formalism to search for inactivity timer setting(s) that render network performance satisfactory, for example, as defined by an optimization metric. For instance, a search strategy can exploit historical values of inactivity timers and possibly combinations thereof, as well as extrinsic information as described supra.

FIG. 12 presents a flowchart of an example method 1200 for configuring inactivity timer(s) based at least in part on historical data on load conditions. In an aspect, the subject example method can be a part of act 920 described hereinbefore. A network management system, or one or more components therein, e.g., load estimation component 610 and timer management component 420, can implement the subject example method. In another aspect, one or more processors that confer functionality to the network management system, or the one or more components therein, also can carry out, at least in part, the subject example method. In yet another aspect, one or more processors that execute at least a portion of the network management system, or the one or more components therein, can perform at least part of this example method 1200. At act 1210, a temporal pattern of load conditions is identified for a specific time interval, e.g., a four-hour period, a 24-hour period, a week, a month. Load conditions can be linked to hardware or radiofrequency resources, as indicated supra. To generate the pattern for the specific time interval, load conditions can be monitored over a period that spans multiple units of the specific time interval, e.g., 10 four-hour units, 10 days, eight weeks, etc. Generation of the pattern also includes classifying the monitored load conditions in accordance with a predetermined set of tiers, wherein the various tiers, e.g., Low, Medium, High, in the set are defined to enable identification of a sequence of load conditions, such as Low-High-Medium-Low-High-Low, during the specific time interval. At act 1220, a classification of load conditions in the identified pattern is supplied. At act 1230, a set of inactivity timer settings is generated based at least in part on the supplied classification of load conditions in the temporal pattern. At act 1240, it is determined if the temporal pattern is to be updated. Such determination can be based on a schedule for pattern generation. Additionally or alternatively, a pattern update can be performed if a predetermined event occurs; the event including at least one of cell or sector performance degradation by a specific margin, addition of a new sector, deployment of a new base station, addition of a new service, upgrade of radio technology coverage of an existing sector or cell. Affirmative outcome in act 1240 redirects flow to act 1210, whereas negative outcome returns flow to act 1250.

At least a benefit of implementation of example method 1200 is that it reduces signaling or processing load incurred to monitor real-time or nearly real-time load condition(s) that determine inactivity timer(s) in accordance with aspects described herein.

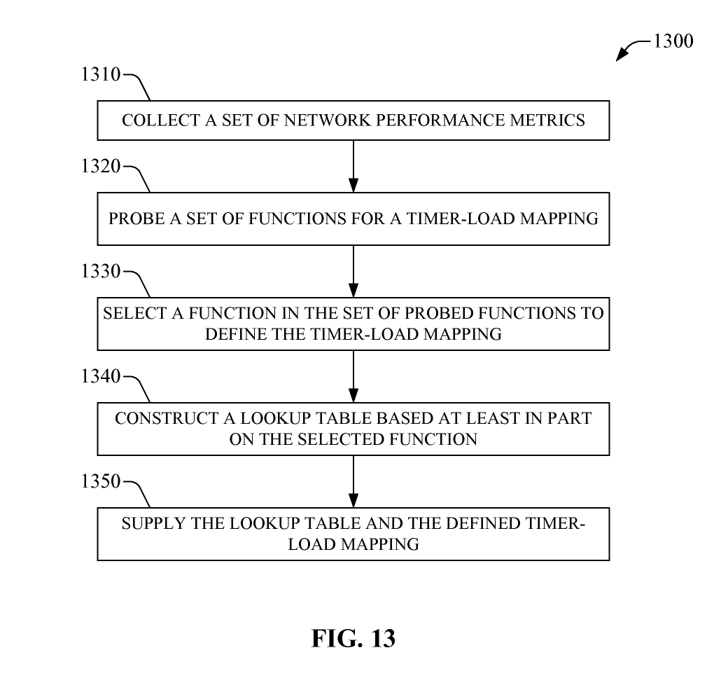

FIG. 13 displays a flowchart of an example method 1300 for defining a load-timer mapping in accordance with aspects described herein. A network management system, or one or more components therein, e.g., mapping generator 440 can implement the subject example method 1300. One or more processors that confer functionality to the network management system, or the one or more components therein, also can carry out, at least in part, the subject example method. Alternatively or in addition, one or more processors that execute at least a portion of the network management system, or the one or more components therein, can perform at least part of this example method 1300. At act 1310, a set of network performance metrics is collected. At act 1320, a set of mathematical functions for a timer-load mapping is probed. The set of mathematical functions is a trial set. Probing the functions in the set can be effected iteratively, assessing a resulting network performance for each function in the set, when the function is employed as the timer-mapping. At act 1330, a function in the set of probed functions is selected to define the timer-load mapping. As discussed supra in connection with operation of mapping generator 440, the selection can be based on observed network performance. At act 1340, a lookup table is constructed based at least in part on the selected function; construction can be implemented as described above (see, e.g., FIG. 2 and associated description). At act 1350, the lookup table and the defined timer-load mapping are supplied. In an aspect, the lookup table and the timer-load mapping are supplied for storage in a memory, or memory element, and utilization by a network component that manages inactivity timer settings.

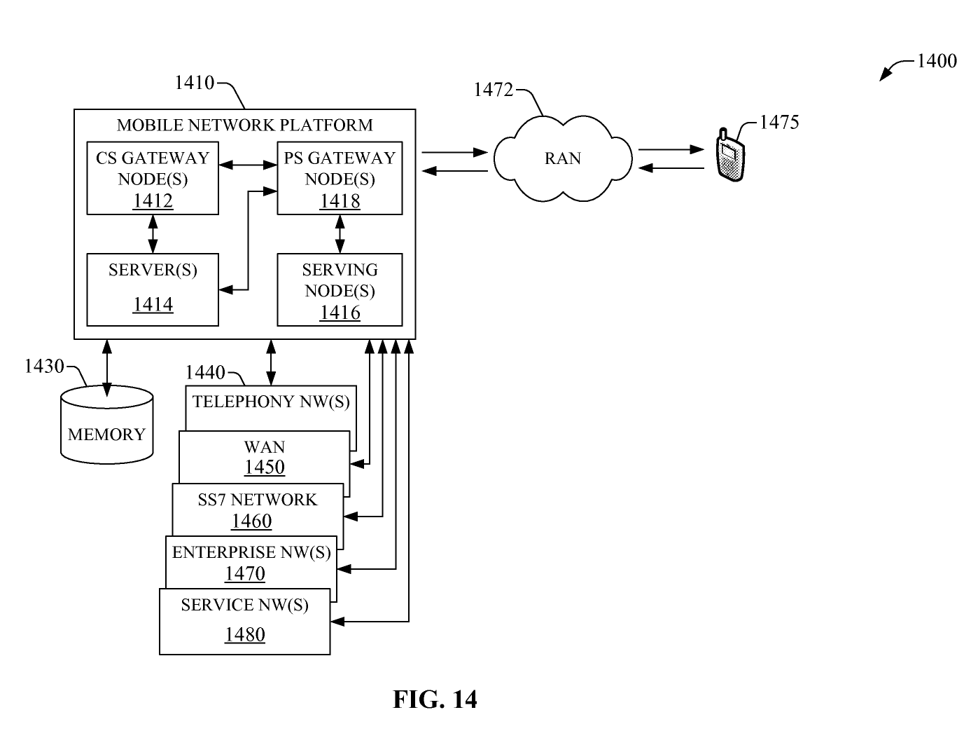

To provide further context for various aspects of the subject specification, FIG. 14 presents an example embodiment 1300 of a mobile network platform 1410 that can enable, facilitate, or exploit aspects or features described herein. Generally, wireless network platform 1410 can include components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. Mobile network platform 1410 includes CS gateway node(s) 1412 which can interface CS traffic received from legacy networks like telephony network(s) 1440 (e.g., public switched telephone network (PSTN), or public land mobile network (PLMN)) or a signaling system #7 (SS7) network 1470. Circuit switched gateway node(s) 1412 can authorize and authenticate traffic (e.g., voice) arising from such networks. Additionally, CS gateway node(s) 1412 can access mobility, or roaming, data generated through SS7 network 1470; for instance, mobility data stored in a visited location register (VLR), which can reside in memory 1430. Moreover, CS gateway node(s) 1412 interfaces CS-based traffic and signaling and PS gateway node(s) 1418. As an example, in a 3GPP UMTS network, CS gateway node(s) 1412 can be realized at least in part in gateway GPRS support node(s) (GGSN(s)). It should be appreciated that functionality and specific operation of CS gateway node(s) 1412, PS gateway node(s) 1418, and serving node(s) 1416, is provided and dictated by radio technology(ies) utilized by mobile network platform 1410 for telecommunication.

In the subject innovation, in addition to receiving and processing CS-switched traffic and signaling, PS gateway node(s) 1418 can authorize and authenticate PS-based data sessions with served mobile devices. Data sessions can include traffic, or content(s), exchanged with networks external to the wireless network platform 1410, such as wide area network(s) (WAN(s)) 1450; enterprise network(s) 1470, which can be embodied in local area network(s) (LANs); and service network(s) 1480. Service network(s) 1480 can embody, at least in part, network(s) such as IP Multimedia Subsystem (IMS), Enhanced 911 (E911), global navigation system(s), or the like. Based on radio technology available to mobile network platform 1410, packet-switched gateway node(s) 1418 can generate packet data protocol contexts when a data session is established; other data structures that facilitate routing of packetized data also can be generated. To that end, in an aspect, PS gateway node(s) 1418 can include a tunnel interface (e.g., tunnel termination gateway (TTG) in 3GPP UMTS network(s)) which can facilitate packetized communication with disparate wireless network(s), such as Wi-Fi networks.

In embodiment 1400, mobile network platform 1410 also includes serving node(s) 1416 that, based upon available radio technology layer(s) within technology resource(s) 1417, convey the various packetized flows of data streams received through PS gateway node(s) 1418. It is to be noted that for technology resource(s) 1417 that rely primarily on CS communication, server node(s) can deliver traffic without reliance on PS gateway node(s) 1418; for example, server node(s) can embody at least in part a mobile switching center. As an example, in a 3GPP UMTS network, serving node(s) 1416 can be embodied in serving GPRS support node(s) (SGSN(s)).

For radio technologies that exploit packetized communication, server(s) 1414 in wireless network platform 1410 can execute numerous applications (e.g., location services, online gaming, wireless banking, wireless device management . . . ) that can generate multiple disparate packetized data streams or flows, and manage (e.g., schedule, queue, format . . . ) such flows. Such application(s) can include add-on features to standard services (for example, provisioning, billing, customer support . . . ) provided by wireless network platform 1410. Server(s) 1414 also can embody, at least in part, a home subscriber server (HSS). Data streams such as content(s) that are part of a voice call or data session can be conveyed to PS gateway node(s) 1418 for authorization/authentication and initiation of a data session, and to serving node(s) 1416 for communication thereafter. In addition to application server, server(s) 1414 can include utility server(s), a utility server can include a provisioning server, an operations and maintenance server, a security server that can implement at least in part a certificate authority and firewalls as well as other security mechanisms, and the like. In an aspect, security server(s) secure communication served through wireless network platform 1410 to ensure network's operation and data integrity in addition to authorization and authentication procedures that CS gateway node(s) 1412 and PS gateway node(s) 1418 can enact. Moreover, provisioning server(s) can provision services from external network(s) like networks operated by a disparate service provider; for instance, WAN 1450 or Global Positioning System (GPS) network(s), which can be part of service network(s) 1480. Provisioning server(s) can also provision coverage through networks associated to wireless network platform 1410 (e.g., deployed and operated by the same service provider), such as femto cell network(s) (not shown) that enhance wireless service coverage within indoor confined spaces and offload RAN resources in order to enhance subscriber service experience within a home or business environment. Furthermore, server(s) 1414 can embody example system(s) described herein, e.g., system 400, 500, or 600.

It is to be noted that server(s) 1414 can include at least one or more processors configured to confer at least in part the functionality of mobile network platform 1410. To that end, the at least one or more processors can execute code instructions stored in memory 1430, for example. Such code instructions comprise instructions to implement one or more of the example methods described herein.

In example embodiment 1400, memory 1430 can store information related to operation of wireless network platform 1410. In particular, memory 1430 can include network policies; subscriber credentials; lookup tables to decode load condition(s); load-timer mapping(s); historical data on at least one of load conditions or inactivity timer settings; or the like. Other operational information can include provisioning information of mobile devices served through wireless platform network 1410, subscriber databases; application intelligence, pricing schemes, e.g., rating plans, promotional rates, flat-rate programs, couponing campaigns; technical specification(s) consistent with telecommunication protocols for operation of radio technology layers within technology resource(s) available to mobile network platform 1410; and so forth. Memory 1430 can also store information from at least one of telephony network(s) 1440, WAN 1450, enterprise network(s) 1470, SS7 network 1460, or service network(s) 1480.

It is to be noted that aspects, features, or advantages of the subject innovation described in the subject specification can be exploited in substantially any wireless communication technology. For instance, Wi-Fi, WiMAX, Enhanced GPRS, 3GPP LTE, 3GPP2 UMB, 3GPP UMTS, UTRAN, HSPA, HSDPA, HSUPA, LTE Advanced. Additionally, substantially all aspects of the subject innovation as disclosed in the subject specification can be exploited in legacy telecommunication technologies; e.g., GSM. In addition, mobile as well non-mobile networks (e.g., internet, or data service network such as internet protocol (IP) television (TV) network) can exploit aspects or features described herein.

As it employed in the subject specification, the term “processor” or “processing unit” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “store,” “storage,” “data store,” “data storage,” “database,” and substantially any or any other information storage component or element relevant to operation or functionality of a system, platform, component or any functional element described herein, refer to “memory components” or entities embodied in a “memory,” or components comprising the memory. It will be appreciated that the memory components or memories described herein can be either volatile memory or nonvolatile memory, or can include both volatile and nonvolatile memory. In addition, the memory components can be computer-readable or computer-accessible entities. Moreover, some memory components can be removable or affixed.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Various aspects or features described herein may be implemented as a method, apparatus, or article of manufacture using standard programming and/or engineering techniques. In addition, various aspects disclosed in the subject specification can be implemented through program modules stored in a memory and executed by a processor (e.g., processor(s) 440), or other combination of hardware and software, or hardware and firmware. Generally, program modules (e.g., applications) can include routines, programs, components, data structures, etc., that perform particular tasks or implement particular abstract data types. The term “article of manufacture” as utilized herein is intended to encompass a computer program or program module accessible from any computer-readable device, memory, carrier, or media. For example, computer-readable media can include, but are not limited to including, magnetic storage devices (e.g., hard disk, floppy disk, magnetic strips . . . ), optical disks (e.g., compact disc (CD), digital versatile disc (DVD), blu-ray disc (BD) . . . ), smart cards, and flash memory devices (e.g., card, stick, key drive . . . ).

What has been described above includes examples of systems and methods that provide advantages of the subject innovation. It is, of course, not possible to describe every conceivable combination of components or methodologies for purposes of describing the subject innovation, but one of ordinary skill in the art may recognize that many further combinations and permutations of the claimed subject matter are possible. Furthermore, to the extent that the terms “includes,” “has,” “possesses,” and the like are used in the detailed description, claims, and drawings such terms are intended to be inclusive in a manner similar to the term “comprising” as “comprising” is interpreted when employed as a transitional word in a claim.

What is claimed is:

1. A system to dynamically configure an inactivity timer, the system comprising:
a component that receives substantially current load conditions in a network; and
a component that configures the inactivity timer based at least in part on the received substantially current load conditions.

2. The system of claim 1, further comprising:
a resource selector that selects a set of network resources to monitor substantially current load condition(s), wherein the selected set of network resources are affected by a predetermined set of one or more inactivity timers;
a component that monitors the substantially current cell load conditions based at least in part on the selected network resources; and
a component that conveys the monitored substantially current cell load conditions.

3. The system of claim 1, wherein the component that configures the inactivity timer inspects a lookup table consisting of a set of (load condition, timer setting) tuples to configure the inactivity timer based at least in part on the received substantially current load conditions.

4. The system of claim 1, wherein the component that configures the inactivity timer computes a timer value through a load-timer mapping to configure the inactivity timer based at least in part on the received substantially current load conditions.

5. The system of claim 1, further comprising a component that generates the load-timer mapping based at least in part on performance of the network.

6. The system of claim 1, wherein the component that configures the inactivity timer further comprises a component that autonomously determines an inactivity timer setting to optimize or nearly optimize performance of the network.

7. The system of claim 1, to configure the inactivity timer based at least in part on historical data on load conditions, further comprising a load estimation component that generates a pattern of load conditions for a specific time interval and supplies a load classification extracted from the pattern.

8. The system of claim 7, wherein the component that configures the inactivity timer determines the inactivity timer based at least in part on the load classification extracted from the pattern.

9. The system of claim 2, wherein the network resources comprise at least one of hardware resources or radiofrequency resources.

10. The system of claim 1, wherein the substantially current load conditions are quantified in accordance with a load metric, in a wireless network, the load metric includes at least one of (i) number of active call sessions, volume of traffic delivered or queued in a downlink channel or uplink channel, rise over thermal noise, or processing load in a network management component or system.

11. A method for dynamically adjusting an inactivity timer, the method comprising:
employing a processor to execute code instructions retained in a memory, the code instructions when executed by the processor implement the following acts:
receiving load conditions in a coverage region of a network; and
adjusting the inactivity timer based at least in part on the received load conditions.

12. The method of claim 11, further comprising:
selecting a set of network resources to monitor load conditions in the coverage region of the network, wherein the selected set of network resources includes resources impacted by a predetermined set of one or more inactivity timers;
monitoring load conditions in the coverage region of the network based at least in part on the selected network resources; and
conveying the monitored load conditions.

13. The method of claim 11, wherein the substantially current load condition(s) are received in at least one of (i) a nearly real-time mode or (ii) a scheduled mode, at intervals determined by a network operator.

14. The method of claim 11, wherein adjusting the inactivity timer based at least in part on the received load conditions includes at least one of computing an updated inactivity timer setting through a mapping amongst load level and inactivity timer value, or accessing a lookup table of (load condition, timer setting) tuples.

15. The method of claim 11, wherein adjusting the inactivity timer based at least in part on the received load conditions comprises autonomously configuring a setting of the inactivity timer to optimize or nearly optimize network performance.

16. The method of claim 11, wherein adjusting the inactivity timer based at least in part on the received load conditions further comprises configuring the inactivity timer based at least in part on historical data on load conditions in the coverage region of the network.

17. The method of claim 15, wherein the configuring act comprises generating a set of inactivity timer settings based at least in part on a classification of load conditions in a temporal pattern of load conditions for a specific time interval.

18. The method of claim 11, wherein the selected network resources comprise at least one of hardware resources or radiofrequency resources.

19. A computer-readable storage medium comprising code instructions stored thereon that, when executed by a processor, cause the processor to carry out the following acts:
receiving substantially current cell load conditions; and
adjusting the inactivity timer based at least in part on the received substantially current load conditions, wherein the adjusting act includes computing an updated inactivity timer setting through a mapping amongst load level and inactivity timer value, or accessing a lookup table of (load condition, timer setting) tuples.

20. The computer-readable storage medium of claim 19, further comprising code instructions stored thereon that, when executed by the processor, cause the processor to carry out the following acts:
selecting a set of network resources to monitor cell load conditions, wherein the selected set of network resources includes network resources affected by a set of inactivity timers;
assessing the cell load conditions in accordance with a metric that quantifies load level, in a wireless network, the metric comprising at least one of number of active call sessions, volume of traffic delivered or queued for delivery in a DL channel or UL channel, rise over thermal noise, processing load in a network component or system;
classifying the load level in accordance with a scale of load levels statically or dynamically configured by a network operator;
encoding the monitored cell load conditions in a set of bits; and
supplying the coded load conditions through at least one of broadband control channel(s), management frames, headers of data packets, payload in management packets, short message service (SMS) communication.
